(19) United States
(12) Patent Application Publication
(10) Pub. No.: US 2008/0249798 A1
(43) Pub. Date: Oct. 9, 2008

(54) Method and System of Ranking Web Content

(76) Inventor: Atul Tulshibagwale, Chandler, AZ (US)

Correspondence Address: INTELLECTUAL PROPERTY LAW GROUP LLP, 12 SOUTH FIRST STREET, SUITE 1205, SAN JOSE, CA, 95113, US

(21) Appl. No.: 12/098,404

(22) Filed: Apr. 4, 2008

Related U.S. Application Data
(60) Provisional application No. 60/910,199, filed on Apr. 4, 2007.

(51) Int. Cl. G06Q 99/00

(52) U.S. Cl. 705/1

(57) ABSTRACT

A system and method for searching web content and cross-site popularity ranking based on a direct measure of popularity. Rank may be determined based on the number of unique page views, in addition to a number of parameters including, but not limited to, aggregate of all users over all periods of time, search within a particular category or search space, among users or authors or both in a particular geography, and within a particular time interval. The system and method avoids fraudulent determination of cross-site popularity ranking such as inflated popularity.

### CROSS-REFERENCE TO RELATED APPLICATIONS

This application claims priority to U.S. provisional patent application No. 60/910,199, filed on Apr. 4, 2007, which is incorporated herein by reference.

### BACKGROUND

1. Field

Aspects of the invention are related to online services for searching web content and ranking results.

2. Background

A search system allows a subset of all resources on the Internet, such as web-pages, images, videos, music and other content, to be selected based on a search specifications or criteria. An ideal search system is one that retrieves all the results that meet the requester's desired criteria and none that do not. A search space is a subset of all the content of the Internet defined by a certain search specification. Ranking systems order the Internet search results based upon certain merits of each valid search result. The merit of each result may be subjective based on the interests of the entity initiating the search. An ideal ranking system is one in which the next result is always less interesting than the previous one.

Currently there are ranking systems that rank which are link based, popularity within a website based, and user action based.

Examples of link based ranking systems include Google™ PageRank™, Technorati™, Yahoo/Inktomi™, Nielsen Blogpulse™, and Bloogz™. Google™ PageRank™ determines a web page's value by the volume of links the page receives, or votes. More specifically, PageRank™ ranks a web page based on the number of links to that web page and the rank of the web page that links to it. Similarly, Technorati™ and the Blogpulse™ ranking systems rank “Top” blogs, posts or stories based on the number of links to the content by other users in a given day. Similarly, Bloogz™ ranks websites and the topics of blogs based on the number of visitors to the site. However, link based ranking systems are inaccurate in predicting the actual relationship between the number of links versus how interesting the blog actually is. As a result, it is not an ideal method for determining which web pages would be of most interest to the requester.

Within site popularity based ranking systems also exist. For example YouTube™ ranks its videos based on most viewed or more linked. However, this ranking system is limited to content within that site and therefore is not capable of ranking popularity of web resources outside of that particular content service.

Another current ranking system involves user action. For example, users of the community-based website Digg™ can review stores posted by other users and vote for it. The stories that receive the most “diggs” or votes become “popular” and receive a higher ranking. Similarly on Netscape™, users can vote for stories that are ranked based on the number of votes it receives. However, this type of ranking system requires users to take some action, hence, capturing only a certain section of the audience. This can subsequently skew the results in favor of that audience.

### SUMMARY

Therefore, there is a need for a searching system, which ranks popularity of the search results with a direct measure, and is capable of ranking more dynamic web content that typically has significantly fewer static links pointing to it (for example: blogs, videos, personal websites, etc.).

It is a further object of the present invention to search web content and rank results such that the most interesting content is place more prominently than other content that matches the search criteria.

A further object of the present invention is to provide a cross-site popularity ranking system.

It is a further object of the present invention to provide a ranking determined based on the number of unique page views, in addition to a number of parameters including, aggregate of all users over all periods of time, search within a particular category or search space, among users or authors or both in a particular geography, and within a particular time interval.

It is a further object of the present invention to prevent fraud such as inflated popularity in determining cross-site popularity ranking.

The above objects are met in an embodiment of the present invention, in which the content of ranking results is requested by a search inquiry.

In an embodiment of the invention, a publisher of web content takes steps to track its content entities. Steps to track the content entity include inserting a reference to an object from the ranking system server from the web resources representing the publisher's content entity.

In an embodiment of the invention, a computer user with a web browser requests a web resource (e.g. web page, image, video, etc. on a website) from a content service. The content service renders the web resource in the user's browser. The web resource embeds a reference to an object from the ranking system server. The ranking system server receives the request to render the object and subsequently determines whether the request constitutes a unique user visit. The ranking system server then renders the object. It sets one or more cookies in the browser if required, and the browser displays the rendered object as an embedded object on the browser screen. The ranking system server then computes the rank for the content entity that includes the web resource. The rank of the content entity is based on the particular topic areas of the content entity and the number of times it has been viewed by users in a particular geographical locale.

In another embodiment of the present invention, the ranking system object is displayed on a browser screen as an object embedded within a web resource or associated with the web-resource. The ranking system object display may indicate the rank of the web content displayed and the scope in which the rank is being displayed. The ranking system object display may also provide controls to the user such as sliders to change the scope. In another embodiment, the user may be required to perform an action on the ranking system object, such as clicking on it, in order to view a more detailed display.

In an embodiment of the present invention, there is a provided a computer implemented method of ranking web content, the method comprising the steps of inserting a reference to a web object from a ranking server into said web content; calculating the number of unique page visits to said web content; calculating one or more criteria related to the characteristics of said web content; computing one or more ranks for said web content based on a combination of said number of unique page visits and said one or more criteria; and displaying said one or more ranks.

In an embodiment of the present invention, there is provided a computer implemented system for ranking web content, comprising: logic for inserting a reference to a web object from a ranking server into said web content; logic for calculating the number of unique page visits to said web content, using said web object; logic for calculating one or more criteria related to the characteristics of said web content; logic for computing one or more ranks for said web content based on a combination of said number of unique page visits and said one or more criteria; and logic for displaying said one or more ranks.

Implementations of the present invention include a method or process, an apparatus or system, or computer software on a computer-readable medium.

These and other embodiments of the present invention are further made apparent, in the remainder of the present document, to those of ordinary skill in the art.

### DETAILED DESCRIPTION OF EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention.

The present invention relates to a method and apparatus for ranking content entities based on popularity and optionally one or more of certain criteria including but not limited to, topic areas of the content entity, geographical locale (or other grouping) of the users viewing web resources belonging to the content entity, and time period of interest.

In an embodiment of the present invention, a publisher of web content takes steps to track its content entities. A content entity comprises a blog, blog post, podcast, video, website, part of a website or other Internet based content, which is recognized as an independent item of publication by users. A content entity may also be related to one or more topics or categories. A publisher may be an individual, a group of individuals or a corporate entity.

In the present embodiment, the ranking system server tracks the content entity by inserting a reference to an object from the ranking system server from one or all the web resources representing the publisher's content entity. The inserted reference represents a publisher's content entity such that when the web resource is requested by a user's web browser, the referenced content is also requested by the browser from the ranking system server.

In another embodiment of the present invention, the ranking system server registers the publisher and the publisher's content entity or entities. The content publisher may register the content entity itself. Alternatively, the ranking system server may infer registration by inspecting the content entity.

In an embodiment of the present invention, a method of ranking content entities comprises computer algorithms implemented to perform processes including: 1) a visit counting procedure; 2) a rank computation procedure; and 3) a fraud prevention procedure. The system of ranking includes the necessary server(s), database(s), memory, processor(s) and computer system components required to perform the algorithms of the system, and result in providing the ranking for cross-site popularity. The system further includes the necessary interfaces between users and the system.

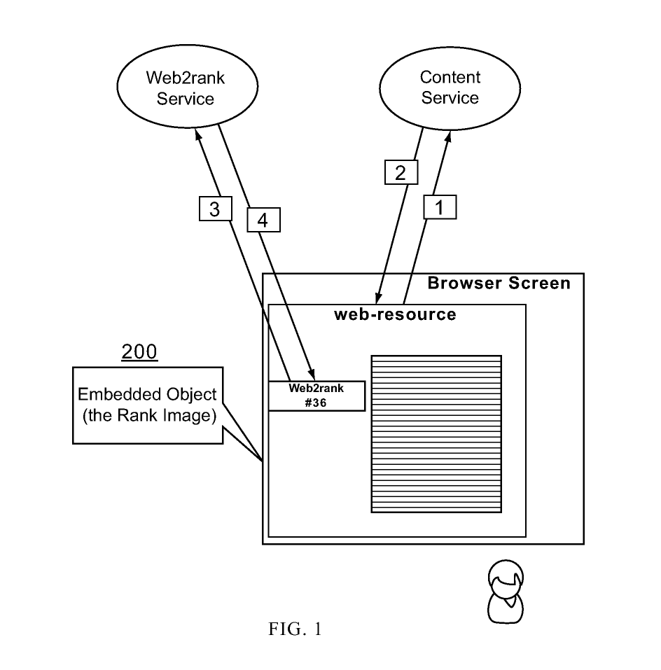

FIG. 1 is a simplified diagram of the visit counting procedure of the system according to an embodiment of the present invention. The visit counting process may begin by inserting an object into the web page of the content that needs to be counted for visits. An HTML object may be images, JavaScript code, iFrames and so forth depending on the content author. As shown in a first step of the visit counting process 1, the user requests a web resource from a content service (or website). In a next step 2, the content service renders the web resource in the user's browser. The web resource embeds or otherwise references the object (a rank image) 200 from the ranking system server such that the object 200 will be displayed from the ranking system server. The browser requests the object 200 in a further step, 3. The ranking system server receives both the request to render the object 200 and any existing cookies previously set. The ranking system server then counts the unique visit, renders the object 200, and sets a unique visit cookie in another step, 4. The ranking system server may also set new cookies in the browser along with rendering the requested object.

As shown in FIG. 1 and in basic steps 1-4, the following describes an example by which the visit counting process may function, according to an embodiment of the present invention. For example, a blogger may maintain a blog at a common blogging site such as blogspot.com. The blog may be available at the URL, for instance, http://mypopblog.blogspot.com. If the blogger desires to display his blog rank using the ranking system, and have the number of visits to his blog counted, he will insert a specific HTML code into his blog page. Inserting this code in the blog causes the page to load an image from the ranking system server in response to the page being loaded by the browser.

According to an embodiment of the present invention, a computer user with a web browser requests a web resource from a content service. A web resource may include the blogging site as discussed above, a web page, image, or video on a website. The content service renders the web resource in the user's browser. A reference to an object from the ranking system server is embedded in the web resource. The browser then requests the referenced object from the ranking system server. The referenced object could be an image, a script such as JavaScript, a style sheet, or some other web content that is fetched without any user action as a part of the web browser's actions to fetch all content referenced by the page.

The ranking system server receives the request to render the object. The browser also automatically sends any cookies it may have that match the domain of the ranking system server website. The ranking system server determines whether the request for this object constitutes a unique user visit to the web resource that referenced the object. The identity of the referencing web resource may be established by inspecting the REFERER parameter sent by the browser. The identity of the referencing web resource may also be established by an explicit indicative parameter or part of the URL in the request for the object.

According to an embodiment of the present invention, a method of identifying a unique visit comprises the ranking system server determining that a visit to a web resource is a “unique visit” if the browser has not sent a cookie, or if the cookie that was sent identifies a user who has not visited the referencing web resource in a given time period, it is counted as a unique visit to that web resource. The ranking system server then renders the object and (if required,) sets one or more cookies in the browser. Such cookies may be used to identify the user. This user identification is used to prevent duplicate counting of the same user's visit to the content entity within a short period of time.

In response to an image request, the ranking system server follows an algorithm that enables counting of user visits to the content entity. An example of the algorithm that enables counting is as follows. If the browser sent a cookie with the ranking system object request, the ranking system server identifies the user based on the unique identifier of the cookie. If no cookie was sent, the ranking system server creates a new unique user identifier. The ranking system server then determines which of the registered content entity (uniquely identified by a content identifier) is being visited based on the standard HTTP header named REFERER that a browser always sends to a website or by the content identifier that is explicitly passed in a parameter of the URL or by the content identifier which is a part of the URL itself. The content identifier, user identifier, and IP address from which the request arrived is recorded in a “content visit” database table. If the browser did not send a cookie, a cookie is set in the response with the user identifier in the cookie. In addition, the domain of the cookie is set to a sub domain of the domains in the ranking system server, such that the browser sends back the cookie to the ranking system server when the same user visits another page that embeds the ranking system object.

In another part of the algorithm, the ranking system server performs a rank computation process according to an embodiment of the present invention. Various database tables are used for rank computation. Examples of some tables in rank computation are a Visit Table, a Content Popularity Table, and a Content Rank Table. The Visit Table stores a user id and IP address for each visit. The Visit Table is updated during the visit counting process as described above. The Content Popularity Table stores the number of visits a particular content has had in a particular time period of interest. The Content Rank Table stores the actual rank of the content with respect to a particular time period, geography identifier and topic identifier. Time periods of interest to users are calendar periods including but not limited to today, yesterday, week to date, month to date, previous year, etc. Geographic identifiers may be as local as a city or county. Topics may vary across a multitude of interests or fields of information for instance, political, news, social, entertainment and consumer interests.

In the rank computation process, the ranking system server periodically sweeps through the Visit Table and computes both the number of visits as well as the rank of the content relative to other contents matching similar criteria. The ranking system server repeats the algorithm for every time period of interest. An example of the algorithm is described below.

For each registered content entity represented by a unique content identifier, “content id,” matching rows are selected from the Visit Table. For each matched row, there is an updating of the number of visits in the “count” field of the row in the Content Popularity Table where the content id is being processed. The geography id is computed in which, if the user id specified in the visit table specifies a preferred geography, that specified geography id is used as the computed geography id. If the user id does not have a preferred geography specified, then a geography id is obtained by resolving the IP address from which the user visit was made. This geography id is stored in the Visit Table based on the information received at the time of the image/object request.

In addition, the rank computation process selects all matching rows for each topic id and geography id from the Content Popularity Table. The rows are then sorted in descending “count” order. For each sorted row, the rank computation process then assigns an increasing rank order starting with “1” and stores the rank in a row of the Content Rank Table with the rank, content id, topic id, and geography id.

In an embodiment of the present invention, the ranking system sever computes a rank for each web resource that participates in the ranking system. A rank is an ordinal number starting from 1 onwards. The lower the number, the greater the popularity of the content entity to which that rank is assigned. The computation of rank for a content entity is based on the number of unique visits the content has received in a given time period.

The ranking system server may compute rank of a content entity within various restricted scopes. Scope restrictions may be based on the geography of the user, the topic/category of the content, the time period during which visits are counted, or other scope restrictions such as affiliation of the visiting user to a specific group or organization. Some of these scope parameters, for example, are specific to the visiting user (e.g. the geography of the user, the affiliation of the user) or the content entity (e.g. the topic/category of the content entity). Other parameters may be independent (e.g. the time period of the visit).

According to an embodiment of the present invention, a rank computation within various restricted scopes is detailed in the example as follows. Assume there are three content entities C1 through C3, and five users U1 through U5. The content entities, C1, C2 and C3 are recognized as topics regarding T1, T2 and T3 respectively. T3 is a sub-topic of T2, but T1 is an independent topic. User U1 and U2 are from geography G1 (A geography is a geographic entity such as a city, county, state, country, group of countries or continent). Users U3, U4 and U5 are from a geography G2. Geographies G1 and G2 are both contained within a geography G3. U1 and U3 have visited content entities C1 and C3, whereas users U2 and U4 have visited all three content entities. User U5 has only visited content entity C2.

In the above example, the ranks of the content entities are as follows:
Scope: <T1, G1>, Rank: C1=rank 1 (C2 and C3 do not get a rank in this scope, because they are not of a relevant topic).
Scope: <T2, G1>, Rank: C3=rank 1, C2=rank 2 (because T3 is a subtopic of T2, and of all the users in G1, users U1 and U2 have visited C3 whereas only user U2 has visited C2)
Scope: <T3, G1>, Rank: C3=rank 1
Scope: <all topics, G1>, Rank: C1=rank 1, C3=rank 1, C2=rank 2 (because of all the users in G1, users U1 and U2 have visited C1 and C3, whereas only user U2 has visited C2)
Scope: <all topics, all geographies>, Rank: C1=rank 1, C2=rank 1, C3=rank 2
   Note: not all combinations are shown here, this only demonstrates how the rank computation is done for a certain scope.

In another part of the algorithm, a fraud prevention process is performed according to an embodiment of the present invention. This process enables the ranking system service to prevent two types of anticipated fraud.

One type of fraud occurs where a hacker writes an automated program (visit “bots”) that continuously visits a particular web content to artificially increase its ranking. Examples of techniques to prevent the fraud include, JavaScript and throttling.

In an embodiment of the invention, the ranking system server can prevent fraud by downloading JavaScript to the user's browser as part of the embedded or referenced rank object. A random number is passed as a parameter in the JavaScript. The JavaScript then uses the random number to compute a derivative number using a one-way hash function (such as one using a SHA1 algorithm). This derived number is posted back to the ranking system server. The ranking system server then computes the same number using the random number and the one-way hash function. It then compares the number it computes with the number it receives from the browser. If the numbers match, the ranking system server knows that the user-agent (i.e. browser) is capable of interpreting JavaScript. It then counts the visit and sends the object displaying the rank back to the browser.

In another embodiment of the invention, the ranking system server can prevent fraud by throttling. Throttling occurs when multiple visits within a short period of time from a user-agent playing a cookie with the same user id, are all counted as one visit. For example, if the same IP address visits the same content entity repeatedly in a short period of time, the counting is throttled such that a small number of visits out of all the visits from that IP address are counted. This helps catch bots that discard cookie information, but allows counting from real user visits, even users who appear as though they come from a single IP address because their network access provider uses a proxy server from which the actual Internet access is made.

The second type of fraud results when a content author wants to show that his web content has a higher-ranking number (i.e. low rank number) when in fact he does not. The content author can copy the rank image of a more popular web content and host it on his web resource. A user viewing the copied rank image and web content then perceives the rank of that content to be the same as the rank of the content from which the rank image originated. To prevent such fraud, the ranking system generated rank objects contain visible digital watermarks that bind the image to the originating site on which it is being displayed.

As such, the method and system of ranking according to the present invention provides for a direct measure of popularity of content across websites. It provides for more accurate results than current link based methods by measuring across dynamic sites and users are not required to take any extra action. Users interested in finding popular content even in specific fields obtain near ideal results.

In another embodiment of the present invention, the ranking system object is displayed on a browser screen as an object embedded within a web resource or associated with the web-resource. The ranking system object display may indicate ranking of the web content displayed and the scope. The ranking system object display may also provide controls to the user, such as sliders to change the scope.

Alternatively, the user may be required to perform an action on the ranking system object. For example, a user may click on the ranking system object in order to view a more detailed display. The controls are moved to change the scope in which the rank is being displayed.

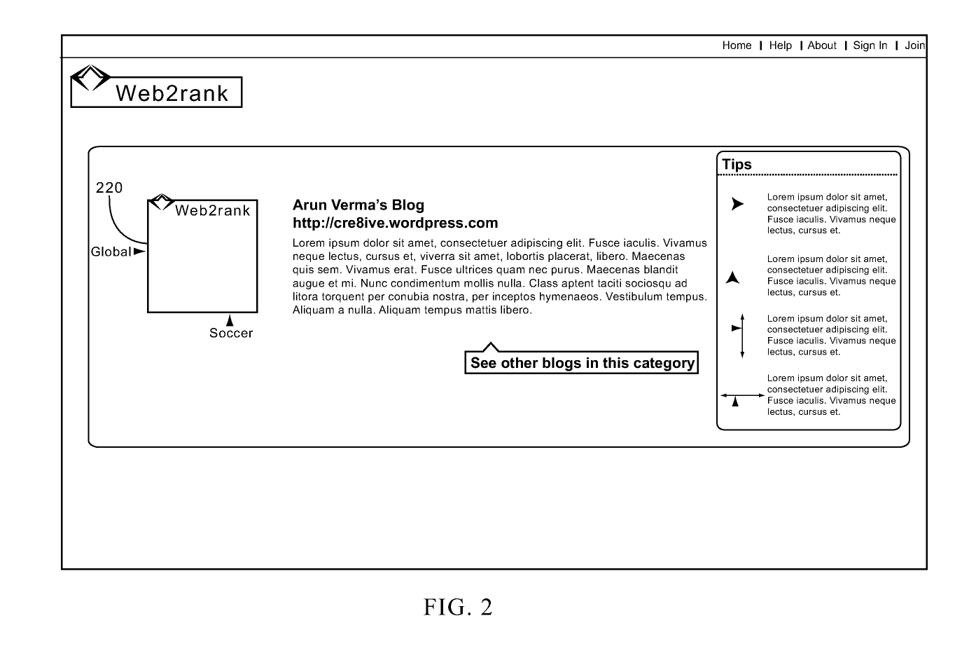

FIG. 2 illustrates the image 200 displayed according to an embodiment of the present invention, in which the image comprises of a rectangular shaped box with a rank number shown in the center of the box. Other representations of the image are of course possible. In this embodiment, the search criteria parameters are displayed on a vertical and horizontal scale. As shown, the search criteria described, for example the word “Soccer”, is positioned in a lower part of the rectangular shape box. The word “Soccer” is the category or specialization selected by the user in his or her search. The word “Global” is located on the left side of the rectangular shaped box and indicates the geographic locale of the user's search criteria. The rank number displayed corresponds to the ranking of the content being displayed within the selected category and geography. The presentation of the search criteria and the shape embodying the criteria and rank may be modified according to specific design. Such presentation is not limited to the order described.

Furthermore, FIG. 2 illustrates two sliding buttons or arrows, “sliders,” one running horizontally on the bottom side of the box 210, and the other running vertically on the left side of the box 220. The user can move the horizontal slider 210 to change the selection of the category or specialization of a search. The word representing this category or specialization displayed on the bottom side would change depending on the positioning of the horizontal slider. Similarly, the user can move the vertical slider 220 to change another parameter of the search criteria, such as the geographical locale of the search criteria. The word representing this parameter displayed in the mid left side would also change depending on the positioning of the vertical slider.

In another embodiment of the present invention, more criteria in the user search can be applied and made adjustable, such as time interval. For example, the background color may be adjusted. The representation of and placement of sliders may also be changed according to design.

In another embodiment of the present invention, more criteria in rank computation scope can be applied, such as the number of hits from people in a group that is not geographical in nature. For example, all users that belong to an online community that only allows CPAs to be members.

In another embodiment of the present invention, the ranking system can provide metrics services or awards. For example, a content author may be awarded an award for ranking among the top 10 bloggers in the topic of politics in the United States.

In a further embodiment of the present invention, the ranking system can be used to cover user action based content ratings. For example, users may rate a blogger as being humorous or explicit, or may provide a quality rating.

Although specific embodiments of the present invention have been described above in detail, the description is merely for purposes of illustration. Various modifications of, and equivalent steps corresponding to, the disclosed aspects of the exemplary embodiments, in addition to those described above, can be made by those skilled in the art without departing from the spirit and scope of the present invention, the scope of which is to be accorded the broadest interpretation so as to encompass such modification and equivalent structures.

What is claimed is:

1. A computer implemented method of ranking web content, the method comprising the steps of:
inserting a reference to a web object from a ranking server into said web content;
calculating a number of unique page visits to said web content;
calculating one or more criteria related to a plurality of characteristics of said web content;
computing one or more ranks for said web content based on a combination of said number of unique page visits and said one or more criteria; and
displaying said one or more ranks.

2. The method of claim 1 wherein said number of unique page visits is calculated by:
receiving a request from a browser to render said web object;
receiving one or more existing cookies previously set for said web object; and
counting a unique visit, rendering said web object, and setting a unique visit cookie where no existing cookies are set.

3. The method of claim 1, wherein said one or more ranks is displayed in said web object.

4. The method of claim 3, wherein said one or more ranks is displayed using a digital watermark in said web object.

5. The method of claim 1, wherein the displaying of said one or more ranks includes providing controls for a user to change the one or more criteria through a user interface.

6. The method of claim 1, wherein the displaying of said one or more ranks includes providing options for a user to select between criteria.

7. The method of claim 1, wherein the computing of said one or more ranks further comprises computing metrics or awards based on said one or more ranks.

8. The method of claim 1, wherein the computing of one or more ranks is based on content ratings based on a user action.

9. The method of claim 1, wherein the computing of said one or more ranks involves maintaining database tables for storing the ranks of said web content with respect to particular criteria.

10. The method of claim 1, wherein the calculating of the number of unique page visits includes taking steps to prevent attempts to fraudulently increase the number of unique page visits.

11. The method of claim 1, wherein said characteristics of said web content comprise time period, topic, and geographical locale of said web content.

12. A computer implemented system for ranking web content, comprising:
logic for inserting a reference to a web object from a ranking server into said web content;
logic for calculating the number of unique page visits to said web content, using said web object;
logic for calculating one or more criteria related to the characteristics of said web content;
logic for computing one or more ranks for said web content based on a combination of said number of unique page visits and said one or more criteria; and
logic for displaying said one or more ranks.

13. The system of claim 12, wherein said number of unique page visits is calculated by:
receiving a request from a browser to render said web object;
receiving one or more existing cookies previously set for said web object; and
counting a unique visit, rendering said web object, and setting a unique visit cookie where no existing cookies are set.

14. The system of claim 12, wherein said one or more ranks is displayed in said web object.

15. The system of claim 14, wherein said one or more ranks is displayed using a digital watermark in said web object.

16. The system of claim 12, wherein the display of said one or more ranks includes controls for a user to change the criteria.

17. The system of claim 12, wherein the display of said one or more ranks includes options for a user to select between criteria.

18. The system of claim 12, wherein the computing of said one or more ranks further comprises computing metrics or awards based on said one or more ranks.

19. The system of claim 12, wherein the computing of one or more ranks is based on content ratings based on a user action.

20. The system of claim 12, wherein the computing of said one or more ranks involves maintaining database tables that store the ranks of said web content with respect to particular criteria.

21. The system of claim 12, wherein the calculating of the number of unique page visits includes taking steps to prevent attempts to fraudulently increase the number of unique page visits.

22. The system of claim 12, wherein said characteristics of said web content comprise time period, topic, and geographical locale of said web content.
